(19) United States
(12) Patent Application Publication
(10) Pub. No.: US 2013/0068040 A1
(43) Pub. Date: Mar. 21, 2013

(54) Rapid analyte collection and testing device

(71) Applicants: Lawrence Loomis, Columbia, MD (US); Leslie Kirkegaard, Gaithersburg, MD (US); Glen Ford, Gaithersburg, MD (US); Robert Greenfield, Chevy Chase, MD (US)

(72) Inventors: Lawrence Loomis, Columbia, MD (US); Leslie Kirkegaard, Gaithersburg, MD (US); Glen Ford, Gaithersburg, MD (US); Robert Greenfield, Chevy Chase, MD (US)

(21) Appl. No.: 13/507,906

(22) Filed: Aug. 6, 2012

Related U.S. Application Data
(60) Provisional application No. 61/573,013, filed on Aug. 4, 2011.

(51) Int. Cl. G01N 1/10

(52) U.S. Cl. CPC G01N 1/10
USPC 73/864

(57) ABSTRACT

A rapid analyte collection and testing device, said device comprising a) a casing, said casing having) a first casing section, said first casing section containing an encapsulated buffer section containing a buffer, and asecond casing section, said second casing section comprising a window on a side of said second section, a complementary mechanism for attachment to said first casing section, an opening at a proximal end of said second casing section; and a non permeable platform strip positioned lengthwise within and extending beyond the second casing section. The non-permeable platform further contains a swab, said swab positioned at the distal end of said non-permeable platform strip, a lateral flow assay positioned downstream from said swab, and a tag, positioned upstream from the capture reagent site.

This application claims priority to Provisional No. 61/573,013, filed Aug. 4, 2011, herein incorporated by reference.

### BACKGROUND OF THE DISCLOSURE

Medical swabs are generally known in the art for use in collecting biological specimens from a patient for further analysis. Such medical swabs commonly comprise a fibrous swab tip at one end of an elongated stick or shaft, which is manipulated to contact the swab tip with selected tissue cells, secretions, fluids or other biological specimens obtained, for example, from within the ear, nose, throat, vaginal opening or other body cavity/opening of a patient.

Alternatively, swab testing may be used as part of environmental condition monitoring For instance, such swabbing may be done in a food service area to determine the presence or absence of environmental or food pathogens or contaminants.

In accordance with standard specimen collection and test preparation techniques, the biological specimen is normally transferred from the swab tip to a slide or other laboratory apparatus such as a test tube or the like, for contact with the selected reagent or reagents and further analysis. The reagents are typically stored in a vial or other breakable container prior to use. However, it is frequently difficult to ensure transfer of a sufficient specimen quantity from the swab tip to the laboratory slide or test tube to ensure accurate test results. Moreover, in many instances, the collected specimen must be transported to an off-site laboratory for performance of selected assays. Delays between the time of specimen collection and actual test performance can result in partial or complete drying of the specimen, with a corresponding decrease in test reliability. In addition, such conventional handling of a biological specimen in the course of preparing and/or performing an analysis undesirably exposes personnel to direct contact with the collected organism, wherein direct contact with infectious or toxic organisms can be especially undesirable.

In this regard, a variety of swab-type specimen collection and test devices have been proposed in efforts to provide enhanced contact between a specimen and reagents, or to sustain the specimen in an improved manner during transport to a laboratory, while at the same time reducing or minimizing risk of direct personnel contact with the collected specimen.

For example, sampling/test kits are now abundantly available for providing transport or testing of specimens in both a hospital and medical office environment. While these tests may be used in the home of a patient, the kits often involve multiple steps or stages, breakable parts, and in many cases, assembly, making them less desirable for use by the general public. For instance it is not unusual for a kit to include three to four parts such as a swab, a collection dish/tray or chamber, in some cases vials of testing solutions or reagents. In test devices involving multiple pieces, the various components used to conduct the test must be kept separated in order to avoid possible contamination of either the testing substrate or the reagents/growth media used in the test.

### SUMMARY OF THE DISCLOSURE

The present disclosure teaches a new rapid analyte collection and testing method and device and a method for the rapid detection of analytes. This device simplifies the process of obtaining and testing biological, chemical, and environmental samples and is designed for home use, use in a hospital, or in a doctor's office. The device is simple, clean, and rapid, producing accurate and rapid results.

In one embodiment of the disclosure, the device is in the form of a pen or cylindrically shaped cartridge or casing. The main body of the detection device further contains a swab, and a lateral flow assay device. Both the swab and the lateral flow assay device are positioned on a platform, with the swab positioned upstream from the lateral flow assay. A permeable membrane is positioned at one end of the top layer of the platform, and at the swab is positioned at the other end of the platform.

The casing is comprised of two sections. In one embodiment the casing is in the shape of a pen or cylinder, and is comprised of two sections. The first section comprises a cap. Within the cap is a small buffer solution, encased within an impermeable foil or paper. After a sample has been taken, the foil is punctured, and the solution is absorbed by the swab, and moves along the permeable membrane to the lateral flow assay, which is positioned in the second section of the casing. At some point along the pathway, the analytes are marked by a gold tag, or some similar tag, whereupon they proceed to the site of the lateral flow assay, to the test site, where the results may be read through an opening in the second section of the casing.

In one embodiment of the disclosure, the results of the assay can be visually determined.

In another embodiment of the disclosure, the results of the assay can be determined by fluorescence.

In yet another embodiment of the disclosure, the results of the assay can be determined by luminescence.

In another embodiment of the disclosure, the result of the assay can be determined by radioactive markers.

### BRIEF DESCRIPTION OF THE DRAWINGS

In order for the advantages of the invention to be readily understood, a more particular description of the disclosure briefly described above will be rendered by reference to specific embodiments that are illustrated in the appended drawing(s). It is noted that the drawings of the disclosure may not be to scale. The drawings are mere schematics representations, not intended to portray specific parameters of the disclosure. Understanding that these drawing(s) depict only typical embodiments of the disclosure and are not therefore to be considered to be limiting of its scope, the disclosure will be described and explained with additional specificity and detail through the use of the accompanying drawing(s), in which:

FIG. 1 discloses a side view of a cylindrical shaped casing for the rapid analyte collection and testing device

FIG. 2 discloses a top view of a cylindrical shaped casing for the rapid analyte collection and testing device;

FIG. 3 discloses a perspective view of a cross section of a cylindrical shaped casing for the rapid analyte collection and testing device.

FIG. 4 discloses a cross section of the cylindrical shaped casing for the rapid analyte collection and testing device, after the encapsulate holding a buffer solution has been intentionally compromised;

FIG. 5 is a cross section of the lateral flow device;

FIG. 6 is a perspective of one embodiment of the locking means of the cap and body of the cylinder;

FIG. 7 is a perspective view of another embodiment of the locking means of the cap and body of the cylinder;

FIG. 8a is a side/cutaway view of the locking mechanism;

FIG. 8b is an enlarged schematic of an embodiment of the locking mechanism;

FIG. 8c is an enlarged schematic of when the female ring cap is in the cap of the cylinder;

FIG. 9 is a cross-sectional view of one embodiment of the lateral flow assay device of the collection and testing device; and

FIG. 10 is a cross-sectional view of another embodiment of the lateral flow assay device of the collection and testing device.

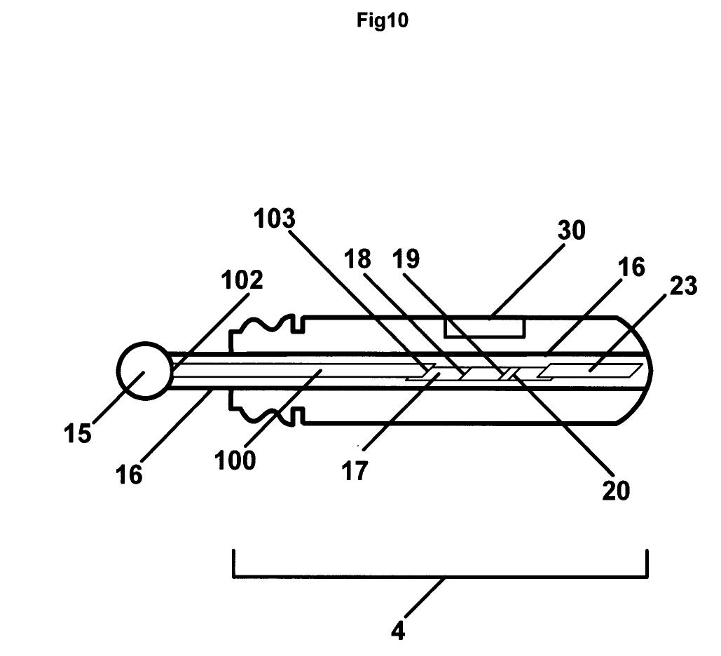

### DETAILED DESCRIPTION OF THE DISCLOSURE

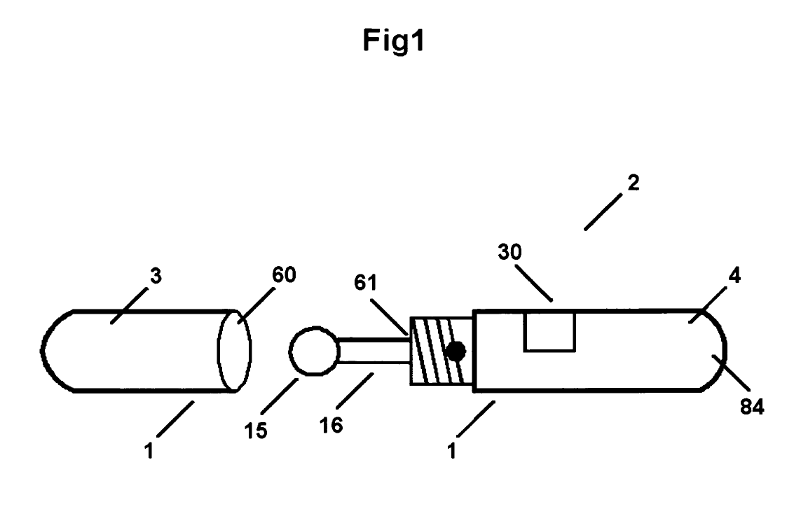

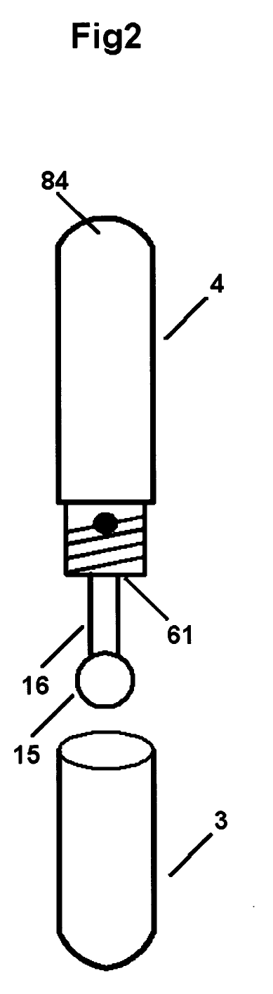

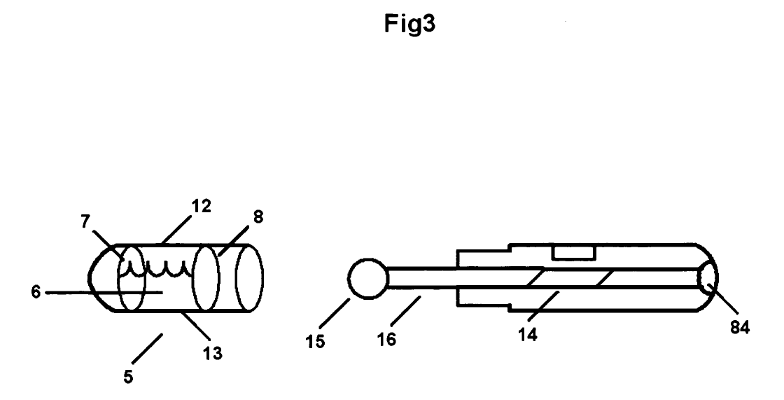

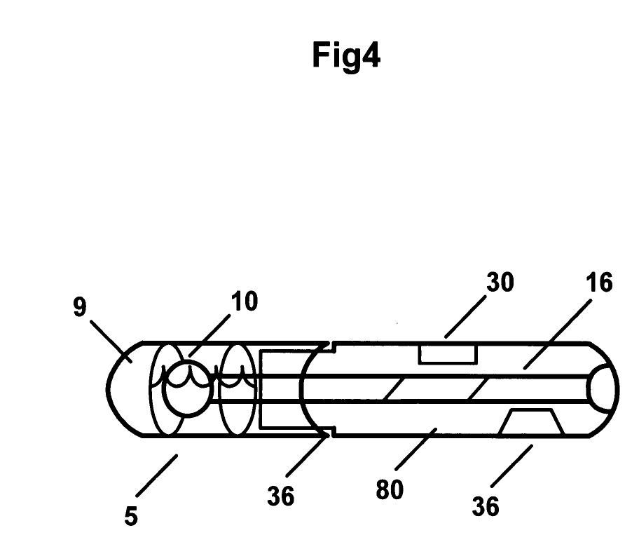

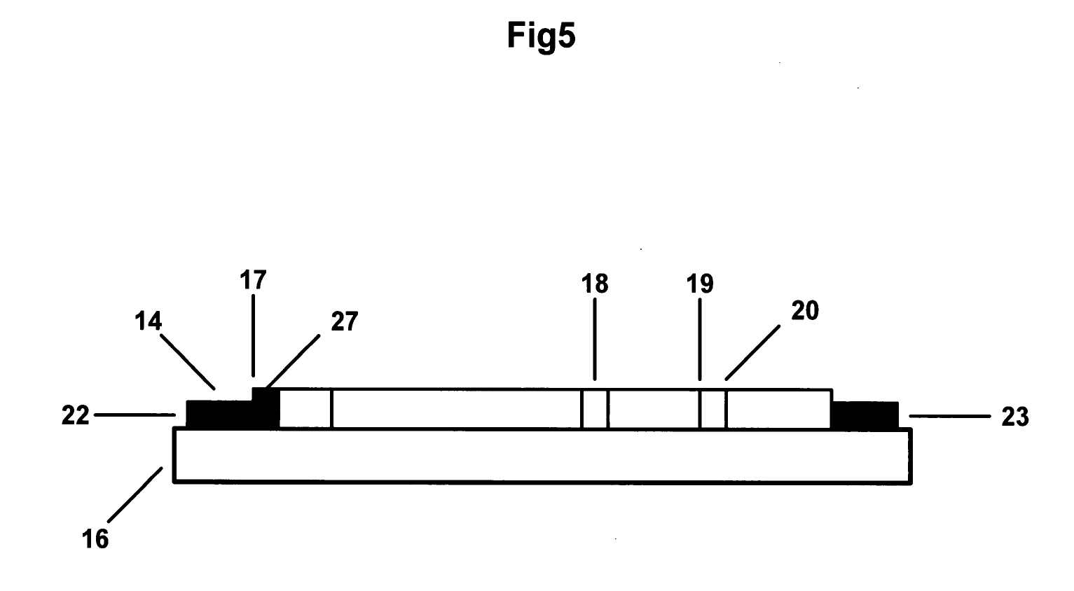

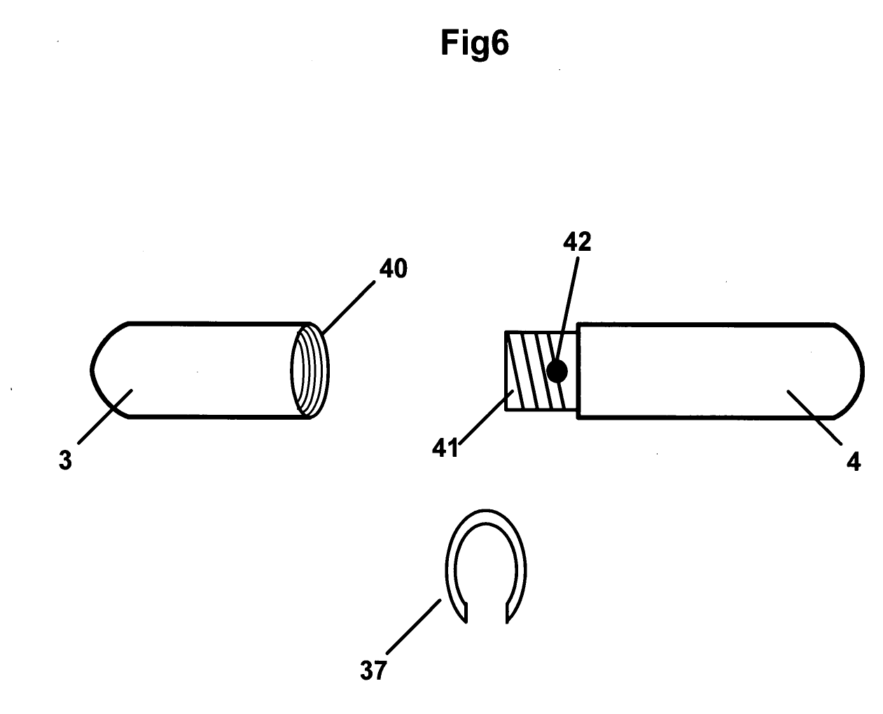

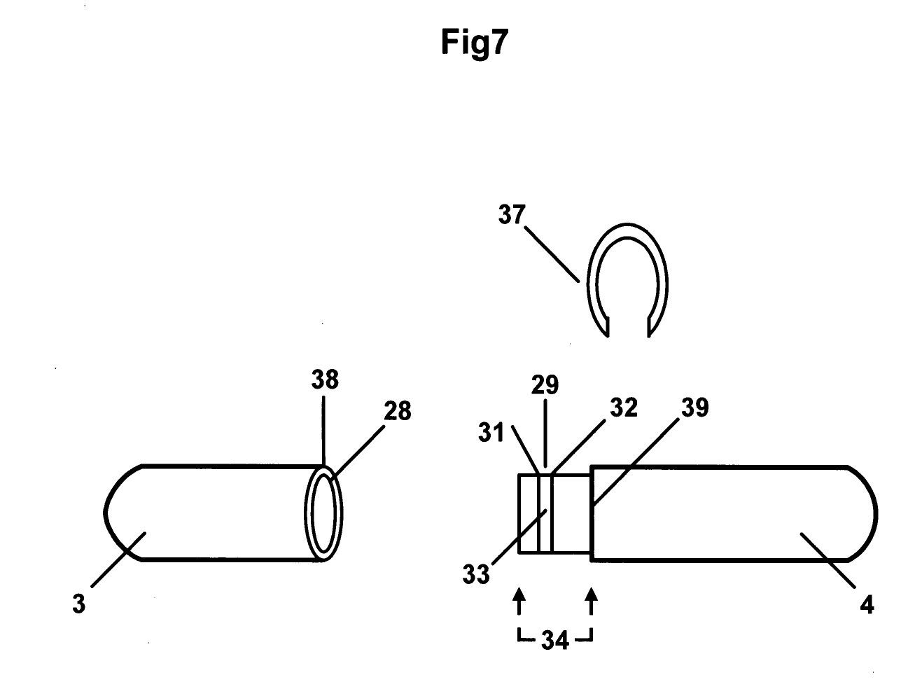

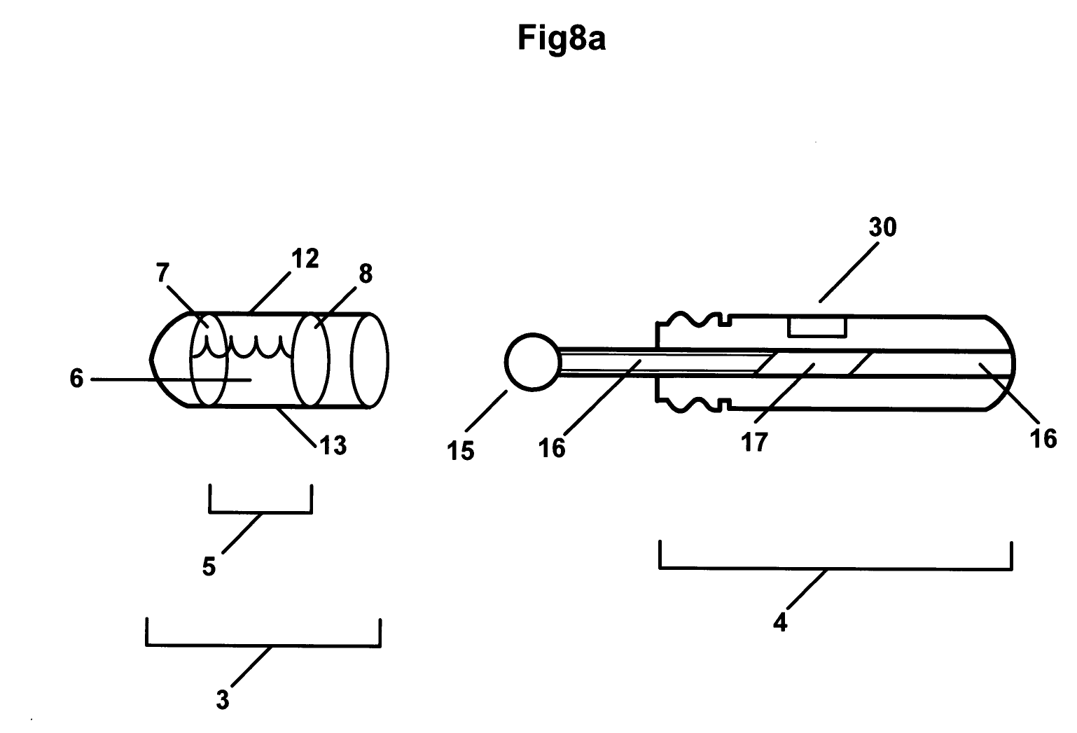

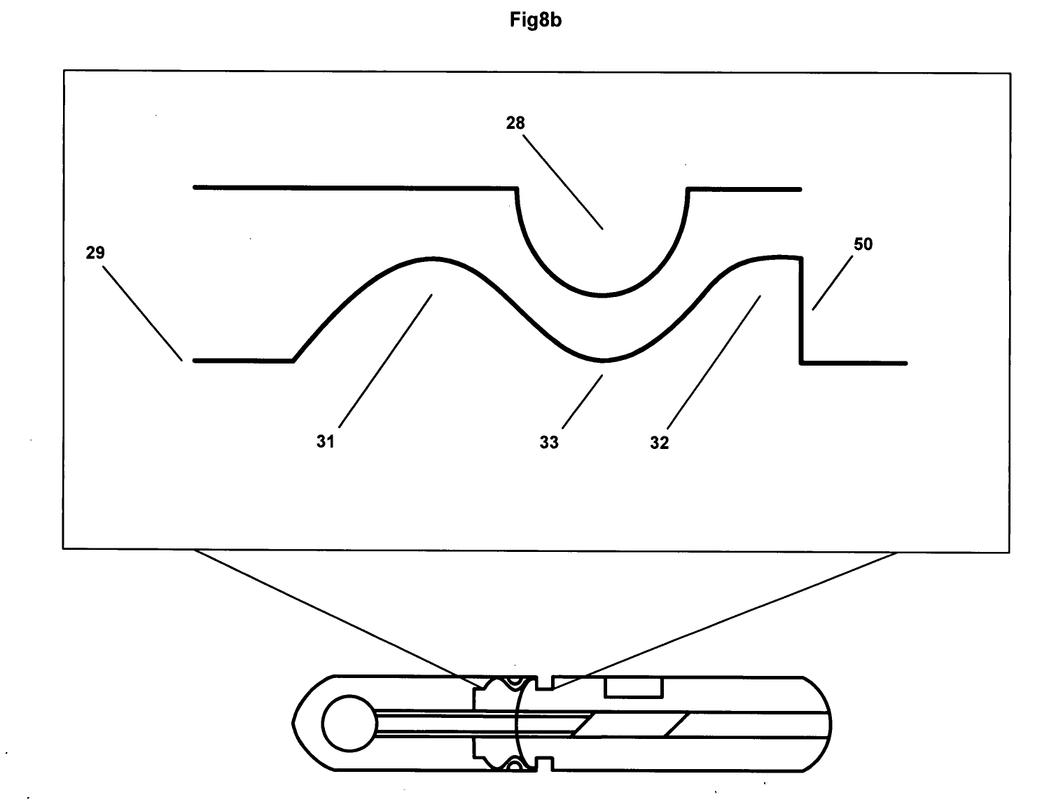

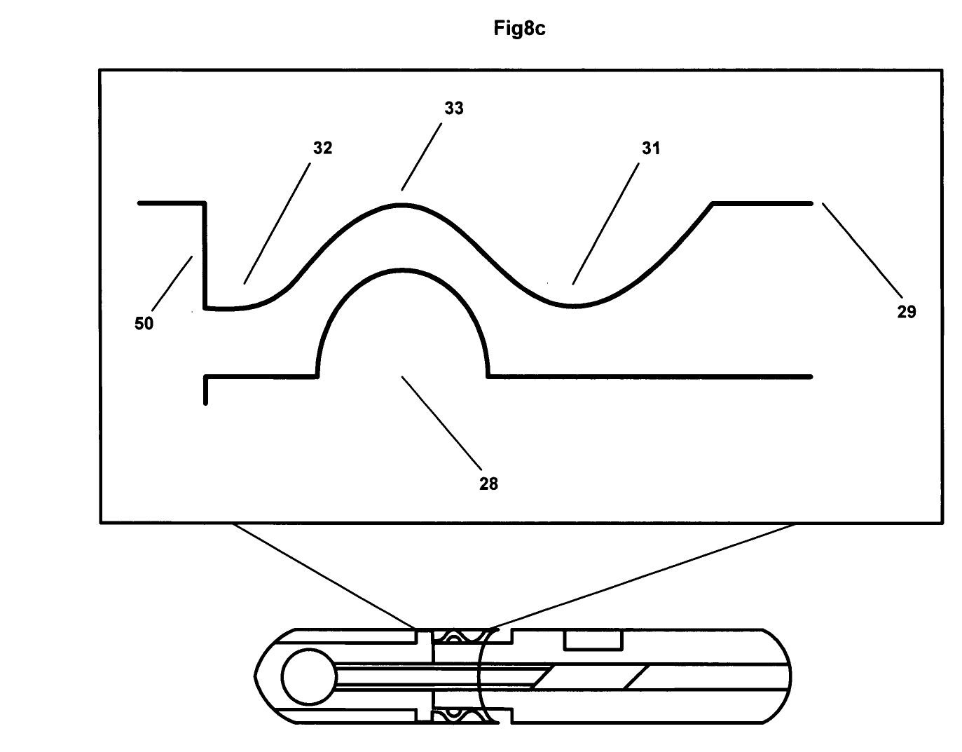

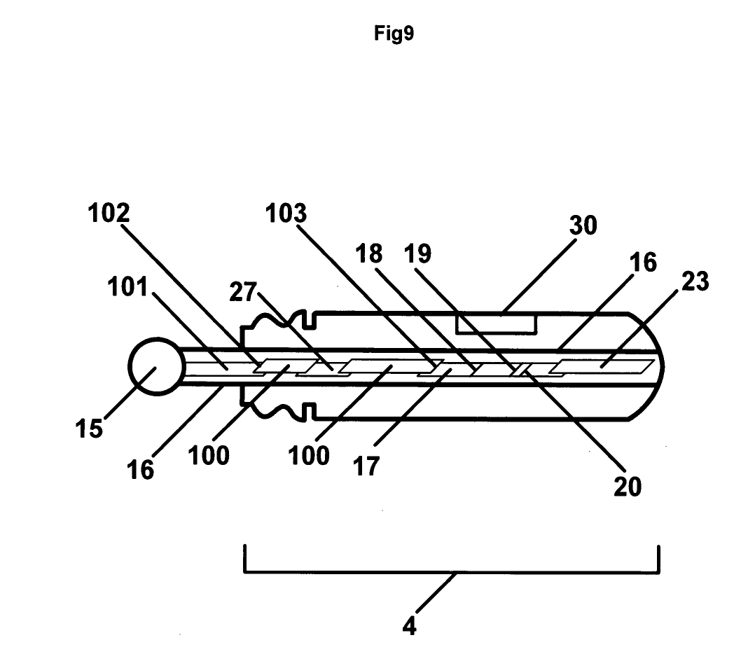

Referring to FIGS. 1-9, in one embodiment of the disclosure, the casing 1 of the rapid analyte collection and testing device 2 is cylindrical in shape, hollow, almost pen shaped, and ranges in size from about one to about ten inches, possibly about four to about seven inches. The casing 1 can be made of a variety of materials, including wood, metal, plastics, cardboard, and paper. A plastic casing 1 is being used in the embodiment described. Additionally, the casing 2 may have other shapes, including but not limited to having the shape of a make-up compact.

Whatever the shape, the casing 1 has a first casing section 3 and a second casing section 4. The first casing section 3, which has an opening 60 at its proximal end, has an encapsulated buffer section 5 positioned within its walls. The buffer 6 can be a sodium or phosphate buffer “chase” solution, or can be any other buffer that is compatible with the test being performed. The buffer 6 is encapsulated in an encapsulate having at least two sides 7, 8, and in fact may be completely encapsulated in a plastic bag like structure 10 affixed to the inner walls 9 so that none of the buffer is in contact with the inner walls 9 of the first casing section 3 of the casing 1. The encapsulating structure does not have to be bag like, but could also have rigid sides 7, 12, 13 except for the side 8, or even 8 can be a “rigid” side as long as it is easily punctureable. In another embodiment, the first casing section is sterile, and the buffer 6 within the first casing section 3 is separated by a breakable wall. It is advantageous that, except for the outside of the casing, that the rapid analyte and collection and testing device 2, be sterile, as should be the buffer solution 6.

The second casing section 4 of the casing 1, which has an opening 61 at its proximal end, comprises a nonpermeable platform strip or nonpermeable membrane 16, upon which resides, at its distal end and on top of said nonpermeable membrane, a lateral flow assay test 14. A sterile swab resides at the proximal end of the nonpermeable membrane 16. The platform strip 16 itself may be flat or round, with the lateral flow assay test strip positioned according. The platform strip 16 should be resilient, having enough flexibility so that it is not brittle, but not so much as to be useless for support. In another embodiment, the nonpermeable platform strip is flat, up through the second casing section 4, but the section of the nonpermeable strip 16 supporting the swab 15 is round. The swab 15 at the proximal end of the nonpermeable platform strip 16 may be comprised of cotton, Dacron, absorbent ceramic, paper, polyester, glass, nylon, mixed cellulose esters, spun polyethylene, polysulfones, and the like and numerous other materials. The swab may be positioned on top of, at the end, or nonpermeable platform 16.

A window 30 in the second casing section 4 of the casing 1, positioned over the lateral flow assay test 14, allows the lateral flow assay test 14 to be visualized The window may be just an opening in the second casing section, it may include a transparent plastic or glass insert or attachment, or it may have a magnifying glass (or magnifying plastic insert).

A plastic support 36 may be positioned underneath or integral with the nonpermeable platform strip, or in fact may serve as the nonpermeable platform. The plastic support 36 may also be in contact with the part of the second casing section 4 beneath the support 36. The platform should support both the swab and the lateral flow assay, and may be anywhere from about 1/16 inch to up to ⅜″ wide, although there may be any number of variations.

The platform may be attached in many different ways in the second casing section (or second section). In one embodiment the distal end of the nonpermeable platform strip is attached to the distal end 84 of the second casing section. In another embodiment, the nonpermeable platform strip is attached lengthwise to the floor 80 of the inside of the second casing section 4. Attachment is by any means (glue, integral molding, etc.). The nonpermeable membrane may be made out of a rigid plastic or wood, or it may be a flexible material such as a flexible plastic. Other materials may be used.

In one embodiment, the platform strip 16 is impermeable, and, preferably, laminated, and to that end, a plastic platform strip may be used. The platform strip 16 is elongated. Positioned on the top side of the platform strip 16 is a permeable membrane testing strip 17, where a sample/conjugate mixture can bind or stick to the immobilized capture reagent site 18, causing a color reaction, indicating the presence of a specific ligand or analyte. The presence and/or amount of analyte in the sample may be determined by the visibility of a line formed by the capture reagent at the capture reagent site 18, specific for the analyte-label reagent conjugate being tested.

There may be more than one capture reagent and more thus more than one capture reagent site when a multiple of analytes are being (possibly) be tested and examined. It is also preferred that there be a control site 19, which is used to verify that the test is not giving any false positives or false negatives (depending on how the control is constructed). There may also be a second control region 20 so that there may be both a negative and a positive control.

The platform strip 16 gives “body” and strength to the longitudinally positioned testing strip. The permeable membrane testing strip 17, which could be more properly called a detection membrane strip 17, may be composed of a series of porous material pieces such as, paper, cotton, polyester, glass, nylon, mixed cellulose esters, spun polyethylene, polysulfones, and the like Preferably, nitrocellulose, nylon or mixed cellulose esters are used for the detection membrane strip 17. It can be attached to the platform strip by any number of means, including a variety of simple glues or tape, as long as the glues do not permeate up through and to the surface of the permeable membrane testing strip 17.

In one embodiment, the sterile swab 15 resides on top of or at the proximal end of an elongated permeable membrane 17 which itself resides on top of the non-permeable platform strip 16, up to and at the point the permeable membrane strip 17 is in contact with the swab 15. More specifically, the sterile swab 15 which will eventually be used to obtain the sample, can either be in physical contact with the proximal of the permeable membrane testing strip 17 or the proximal end 21 of the sample receiving pad 22, although it should be noted that the swab 15 can take the place of the sample receiving pad 22. The swab is positioned beyond the opening of the second casing section 4, and may, in fact, extend to within a few millimeters or a fraction of a millimeter from the encapsulated buffer section, when the first casing and second casing section are in the “first closed position (see infra). The sample receiving pad 22, may be composed of a series of porous material pieces such as, paper, cotton, polyester, glass, nylon, mixed cellulose esters, spun polyethylene, polysulfones, and the like. Preferably, paper, cotton, polyester, glass fiber, or polyethylene are preferred for the sample receiving pad. As noted above, the sample receiving pad 22 may be considered superfluous.

A reservoir absorbent pad 23 is positioned on top of and at a distal end 24 of the non-permeable membrane strip 16 while in contact with the distal end 25 of the permeable membrane test strip 17. In one embodiment, the proximal end 26 of the reservoir absorbent pad 23 overlaps the distal end 25 of the permeable membrane test strip 17. The reservoir absorbent pad 23 helps draw the fluid sample across the permeable membrane testing strip 17 by capillary action. The reservoir absorbent pad 23 may be composed of a series of porous material pieces such as, paper, cotton, polyester, glass, nylon, mixed cellulose esters, spun polyethylene, polysulfones, and the like. Preferably, the reservoir absorbent pad 23 is comprised of paper, cotton, polyester, glass fiber, or polyethylene.

In order to determine whether or not there is a positive result at the site of the reaction site, the analytes must be tagged.

For instance, the tags are gold particles, attached to an antibody (or antigens in some instances, depending on the use of this lateral flow device), and are preferably larger than 20 nm, more preferably in the range of about 20 to 100 nm, and most preferably in the range of 20 to 40 nm. The gold sol labeled antigens/antibodies are dried and deposited on the strip. Put another way they can be lyophilized on the lateral flow assay strip.

The metal sol particles to be used in accordance with the present disclosure may be prepared by coupling the analyte directly to the gold particle. Additionally, the labeled component may be prepared by coupling the analyte to the particle using a biotin/avidin linkage. In this latter regard, the substance may be biotinylated and the metal containing particle coated with an avidin compound. The biotin on the analyte may then be reacted with the avidin compound on the particle to couple the substance and the particle together. In another alternative form of the disclosure, the labeled component may be prepared by coupling the analyte to a carrier such as bovine serum albumin (BSA), key hole lymphocyananin (KLH), or ovalbumin and using this to bind to the metal particles.

The metal sol particles to be used in accordance with the present disclosure may be prepared by methodologies which are well known. For instance, the preparation of gold sol particles is disclosed in an article by G. Frens, Nature, 241, 20-22 (1973). Additionally, the metal sol particles may be metal or metal compounds or polymer nuclei coated with metals or metal compounds, as described in U.S. Pat. No. 4,313,734. Other methods well known in the art may be used to attach the analyte to gold particles. The methods include but are not limited to covalent coupling and hydrophobic bonding. The metal sol particles may be made of platinum, gold, silver, selenium, or copper or any number of metal compounds which exhibit characteristic colors.

Similarly, the analyte does not necessarily have to be attached to a metal sol particle, but may instead be attached to dyed or fluorescent labeled microparticles such as latex, polystyrene, dextran, silica, polycarbonate, methylmethacrylates and carbon. The metal sol particles, dyed or fluorescent labeled microparticles should be visible to the naked eye or able to be read with an appropriate instrument (spectrophotometer, fluorescent reader, etc.). In an alternative embodiment, the analytes or the antibodies may be tagged with a radioactive particle, and the reading of the results done by a specially designed machine. However, for home use and for use in the doctor's office, the visible tag may be used.

There are a number of ways in which the gold labeled antigens may be deposited on the strip, including lyophilization and drying.

In yet another embodiment of the disclosure, the analytes may be attached to microspheres. This has the effect of increasing the number of reactive sites (epitopes) in a given area. Analytes may be attached to these alternate solid phases by various methodologies.

For instance, reactive microspheres (MX-Covaspheres.sup.R of diameter 0.5 micrometers or 0.9 micrometers) purchased from Duke Scientific Corporation, Pal Alto, Calif. 94303, or other suppliers, may be used to covalently attach analytes. The binding is at the amino groups of the protein if covalent methodology is used. In addition, hydrophobic or electrostatic domains in the protein may be used for passive coating. A suspension of the spheres is mixed after sonication with the antigens/antibodies in water or in a phosphate buffer solution, after which they are incubated at room temperature for 10-75 minutes. The mixture is then centrifuged and the pellets containing the antigen/antibody-linked microspheres are suspended in a buffer containing 1-5% wt/volume bovine serum albumin (BSA) for 1 hour at room temperature. The BSA blocks any unreacted surfaces of the microspheres. After one more centrifugation, the spheres are resuspended in buffer (TBS with 5% BSA) and stored at 4 degrees C. before using.

The solid phase particles may comprise any one of known, water dispersable particles, such as, the polystyrene latex particles disclosed in U.S. Pat. No. 3,088,875. Such solid phase materials simply consist of suspensions of small, water-insoluble particles to which antigens/antibodies are able to bind. Suitable solid phase particles are also disclosed, for example, in U.S. Pat. Nos. 4,184,849; 4,486,530; and 4,636,479.

In another embodiment of the disclosure, the analytes may be attached to fluorescent microspheres or fluorescent microparticles. Said fluorescent microparticles may be purchased from Duke Scientific, Palo Alta, Calif. 94303 and are listed as Green, Red, or Blue fluorescent 0.4 micron microspheres (Product Bulletin 93). They are also available from Molecular Probes, Eugene, Oreg. 97402 and are listed as FluoroSpheres; Blue, Yellow-Green, Nile Red, Orange, Red, Crimson, Dark Red and Far Red in micron sizes from 0.03 to 5.0. Other manufactures also supply fluorescent microspheres. Characteristically, fluorescent microspheres incorporate fluorescent dyes in the solid outer matrix or in the internal volume of the microsphere. The fluorescent spheres are typically detected by a fluorescent reader that excites molecules at one wavelength and detects the emission of fluorescent waves at another wavelength. For example, Molecular Probes Nile Red particles excite at 526 nm at emit at 574 nm, the Far Red excites at 680 nm and emits at 720 nm and the Blue excites at 365 nm and emits at 430 nm. In a lateral flow format, detection of fluorescent microparticles requires the use of a reflectance reader with an appropriate excitation source (HeNe, Argon, tungsten or diode laser) and an appropriate emission filter for detection. Use of diode lasers allows for use of detection systems that use low cost lasers with detection above 600 nm. Most background fluorescence is from molecules that emit fluorescence below 550 nm. Detection by this method is not by the naked eye, but by a fluorescence reader.

Fluorescent microspheres contain surface functional groups such as carboxylate, sulfate and aldehyde groups, making them suitable for covalent coupling of proteins and other amine containing biomolecules. In addition, sulfate, carboxyl and amidine microspheres are hydrophobic particles that will passively absorb almost any protein or lectin. Coating is thus similar as for non fluorescent microspheres (MX-Covaspheres or other latex microparticles). A suspension of the fluorescent spheres is mixed after sonication with the antigens/antibody in water or in a phosphate buffered solution, after which they are incubated at room temperature for 10-75 minutes. EDAC (soluble carbodiimide), succinimidyl esters and isothiocyanates as well as other crosslinking agents may be used for covalent coupling of proteins and lectins to the microspheres. After the protein has attached to the surface of the microparticles, the mixture is centrifuged and the pellets containing the antigen or antibody finked to the fluorescent microparticles are suspended in a buffer containing 1-5% bovine serum albumin for one hour. After one more centrifugation, the spheres are resuspended in buffer (TBS with 5% BSA or other appropriate buffers) and stored at 4 degrees C. before use.

The solid phase particles useful in connection with the disclosure may comprise, for example, particles of latex or of other support materials such as silica, agarose, glass, polyacrylamides, polymethyl methacrylates, carboxylate modified latex and Sepharose. Preferably, the particles will vary in size from about 0.2 microns to about 10 microns. In particular, useful commercially available materials include 0.99 micron carboxylate modified latex, cyanogen bromide activated Sepharose beads (Sigma), fused silica particles (Ciba Coming, lot #6), isothiocyanate glass (Sigma), Reactogel 25DF (Pierce) and Polybead—carboxylate monodisperse microspheres. In accordance with the disclosure, such particles may be coated with a layer of antigens coupled thereto in a manner known per se in the art to present the solid phase component.

The gold tag or other tags may be located in a number of places upstream from the capture reagent site. In some instances, the tag may be in the buffer solution. In another instance, the tags may be positioned by lyophyilization on the test strip between the swab 15 and the capture reagent site 18. In another embodiment, the tags are dried or lyophilized in the swab 15 itself.

If tags are positioned between the swab 15 and the capture reagent site 18, the tags may be contained (for release upon contact with the buffer) in a conjugate pad 27, or the tags may be dried or lyophilized directly on the permeable membrane strip. The conjugate pad 27 may be of cotton, Dacron, absorbent ceramic, paper, polyester, glass, nylon, mixed cellulose esters, spun polyethylene, polysulfones, and the like and numerous other materials

The capture reagent site 18 may contain an antibody specific for a particular analyte, antigen, antibody, protein, carbohydrate, or any other biological or chemical structure. Alternatively, the capture site a capture may be an analyte, antigen, antibody, protein, carbohydrate or another biological structure, and the sample may include the target antibody. The capture site 18 may be lyophilized or dried on the lateral flow permeable strip.

The permeable membrane strip 17 and conjugate pad or membrane 27 may optionally contain bovine serum albumin (BSA) and detergents which act as effective blockers to prevent loss of human antibody, other ligands, haptens, proteins or analytes, by non-specific attachment to either the membrane or colored conjugate or both.

Different forms and types of lateral flow assays may be used. Some of the lateral flow assays will have all of their components in a single plane on the lateral flow test strip, while lateral flow assays will have the components reside on top of the test strip.

In one embodiment of the lateral flow assay that is used, the assay strip device is composed of the non-permeable platform strip 16, and the permeable membrane testing strip 17 is positioned on top of the non-permeable platform strip 16. The proximal end of the permeable membrane strip 17 non-permeable platform strip 16 having the capture reagent 18 is shorter than the non-permeable platform strip. A conjugate pad 27 positioned on top of the non-permeable platform. This conjugate pad comprises a permeable membrane containing a conjugate, with the conjugate pad being positioned upstream from said permeable membrane testing strip. The conjugate pad 27 is distinct and not in contact with said permeable test strip. The proximal end of the conjugate pad is in physical contact with the swab 15. A proximal end of a semi-permeable membrane is positioned 100 on top of or underneath and in contact with the distal end of conjugate pad. The distal end of the semi-permeable membrane 100 overlaps onto a proximal end of the permeable membrane strip 17. A sample receiving pad 101 is positioned on top of a proximal end of said semi-permeable membrane.

In another embodiment to the preceding structure, there is no conjugate pad 27, and the conjugate is in either a dehydrated or lyophilized form in the swab 15, or the conjugate is in the buffer solution. In that circumstance, the semipermeable membrane 100 is positioned on the nonpermeable platform strip 16, wherein the proximal end 102 of the semipermeable membrane 100 is in communication with the swab 15, and the distal end 103 of the semipermeable membrane 100 is in communication with the proximal end of the permeable membrane strip 17. The distal end of the semi-permeable membrane strip 100 can be positioned on top of, or underneath, the proximal end of permeable membrane strip 17.

In another embodiment of the disclosure the lateral flow system can be adopted for the use of a luminometer. In another embodiment the tag is fluorescent, and can be seen under a “black light.”

In another embodiment the proximal end of the permeable membrane strip 17 may wrap around the proximal end of the proximal end of the nonpermeable membrane and the Returning to the casing 1 of the rapid analyte collection and testing device 2, the casing has a two different means of securing one section of the casing to the other, both involving a two step process, which is further used to test the sample that has been obtained.

In one embodiment of the disclosure, the first casing section 3 and the second casing section 4 are held together by a male ring 28 and a female ring 29 snap, with the female ring snap comprising two rings 31, 32 with a gap 33 between them, positioned on an extension piece (or tube) 80 at the proximal end of and integral with the second casing section, wherein the extension piece of the second casing has a slightly smaller diameter than the diameter of the first casing section 3. The male ring 28 is positioned in the inner circumference e of the first casing section 3. It should be noted that it does not matter whether or not the male ring is in the first casing section or second casing section 4, with the second casing section overlapping the first casing section 3, with the first casing section 3 comprising the female ring snap 29 and the second casing section 4 comprising the male ring 28. The second ring 32 of female ring snap 29 has a flat outer wall 50 on the second ring.

The swab 15 is positioned near the encapsulated buffer section 5, but is not penetrating it until the two sections 3,4, are pushed together. The swab may be anywhere from 0.5 millimeters to 10 millimeters, or more, from the encapsulated buffer section 5. When in the normal “closed” position, the male ring fits within the gap 33 positioned between rings 31, 32. The extension piece 80 may further comprise a removable demi circumferential blocking piece 37, positioned between the distal rim 38 of the first casing section 3 of the casing 1 and the proximal rim 39 of the second casing section 4 of the casing 1. This prevents the premature puncturing of the encapsulated buffer section 5 by the swab.

It should be noted that the circumferential rings may be substituted with other mechanisms that allow for securing the first and section sections of the casing together, once the test is conducted.

To use the testing device, it is best to first remove the demi circumferential blocking piece 37. The circumferential the casing is opened by pulling the first casing section 3 and the second casing section 4 apart, and the sample is swiped by the swab 3. The first casing section 3 and the second casing section 4 are pushed together so that the proximal rim 38 of the first casing section 3 and the distal rim 39 of the second casing section 4 are in contact or positioned next to each other and the male ring 28 is forcibly moved past the second ring 32 of the female ring snap. The swab 15 penetrates the encapsulated buffer section 5, whereupon the buffer saturates the swab 15, carrying the analyte to the site of the conjugate (if the conjugate has not been incorporated in the buffer), down to the capture reaction site 18, where a signal (in the form of fluorescence or a red line) emerges if the results are positive.

In another embodiment of the device, mated threads 40,41 are embedded in the first casing and second casing sections 3,4 of the casing 11. Instead of male and female mating pieces, and when closing both the second casing and first casing sections, the thread of the first casing section is twisted past a bump stop 42 positioned at the proximal end of the thread 41. The distal side 42a of the bump stop 42 has a flattened wall to prevent the device from being opened once the test has been commenced.

In another embodiment of the disclosure there is no bump stop 42, or second ring, 32, and it is merely the presence of the demi circumferential blocking piece 37 that prevents the first casing section and the second section from completing mating, and thus preventing the puncturing of the encapsulated buffer section by the sterile swab.

In other embodiments of the device the closing and securing mechanisms may be reversed between the first casing section 3 and the second casing section 4 of the casing. Additionally, other shapes and sizes may be used for this device, wherein instead of having a first casing section and a second casing section, there may be a first section and a section section.

While the disclosure has been described in conjunction with specific embodiments, it is evident that many alternatives, modifications and variations will be apparent to those skilled in the art in light of the foregoing description. Accordingly, the present disclosure attempts to embrace all such alternatives, modifications and variations that fall within the spirit and scope of the appended claims.

What is claimed is:

1) A rapid analyte collection and testing device, said device comprising:
a) a casing, said casing having:
i) a first casing section, said first casing section comprising
A) an encapsulated buffer section, said encapsulated buffer section containing a buffer;
B) a mechanism for attachment to another section; and
C) an opening at one end of said first casing section;
ii) a second casing section, said second casing section comprising:
A) a window on a side of said second section;
B) a complementary mechanism for attachment to said first casing section;
C) an opening at a proximal end of said second casing section;
b) a non permeable platform strip positioned lengthwise within and extending beyond the second casing section, said non-permeable platform comprising:
i) a swab, said swab positioned at the distal end of said non-permeable platform strip;
ii) a lateral flow assay positioned downstream from said swab, said lateral flow assay comprising:
A) a permeable membrane strip, said permeable membrane strip positioned under said window of said second casing section, said permeable membrane strip positioned on top of said non-permeable platform beginning at the site of the swab;
B) a capture reagent site positioned on top of said permeable membrane strip;
C) a reservoir absorbent pad positioned at a proximal end of the permeable membrane strip, downstream from said capture reagent site; and
iii) a tag, said tag being selected from the group comprising gold particles, iron particles, fluorescent, and luminescent elements, wherein said tag is positioned upstream from said capture reagent site;
wherein said swab is positioned next to said encapsulated buffer section such that when said first casing section and said second casing second are pushed or screwed together in a second locking position after said swab has been used to obtain a sample, said encapsulated buffer section is ruptured, saturating said swab and carrying said sample to said reagent testing site, where a specific labeled analyte is detected.
